(19) United States
(12) Patent Application Publication
(10) Pub. No.: US 2006/0093037 A1
(43) Pub. Date: May 4, 2006

(54) Device and method for decoding and digital broadcast receiving apparatus

(75) Inventor: Yoshimi Enomoto, Chiba (JP)

Correspondence Address: PHILIPS INTELLECTUAL PROPERTY & STANDARDS, P.O. BOX 3001, BRIARCLIFF MANOR, NY, 10510, US

(73) Assignee: koninkilijke phillips electronics n.v.

(21) Appl. No.: 10/523,427

(22) PCT Filed: Jul. 17, 2003
(86) PCT No.: PCT/IB03/03255

§ 371 Date: Jan. 28, 2005

(30) Foreign Application Priority Data
Aug. 1, 2002 (JP) 2002-224652

(51) Int. Cl. H04N 7/12

(52) U.S. Cl. 375/240.14

(57) ABSTRACT

To display a plurality of pictures with proper quality corresponding to a display size in the case of displaying a plurality of pictures on a screen. Resource assigning section 18 assigns a resource of decoding processing, such as inverse DCT processing or movement compensation/interframe predictive decoding processing, per a picture on the basis of display size information. Inverse DCT section 12, 13 performs the inverse DCT processing using DCT coefficient with resource assigned in the resource assigning section 18 to obtain predicted error. Movement compensation/interframe predictive decoding section 14, 15 performs the movement compensation/interframe predictive decoding processing using a motion vector and the predicted error to obtain the decoded picture. Scaling section 16, 17 performs the scaling processing to the decoded picture on the basis of the display size information.

### BACKGROUND OF THE INVENTION

1. Field of the Invention

The present invention relates to a device and a method for decoding and a digital broadcast receiving apparatus, particularly to a device and a method for decoding and a digital broadcast receiving apparatus using MPEG (Motion Picture Experts Group) image coding.

2. Description of Related Art

In the field of picture display technologies, two or more pictures are displayed on a display screen. When two or more pictures are displayed on a display screen, pictures sent through respective channels are conventionally decoded by individual decoders separately, and format conversion or scaling is performed on the respective decoded signals, which are then displayed on a screen. This method requires as many decoders, formatting sections and scaling sections as pictures to be displayed on the screen, which will increase the size of the apparatus configuration.

When carrying out MPEG image decoding processing, there is a trend that by intentionally manipulating spatial frequencies and motion vectors, signals are decoded to predetermined desired picture sizes, that is, so-called “down-decoding processing” is performed in recent years. This down-decoding technology is disclosed, for example, in Unexamined Japanese Patent Publication No. 2000-341695 (corresponding European Patent Application EP1054566A1). Carrying out this down-decoding processing does not require as many decoders as pictures to be displayed on a screen and allows the processing capacity of the decoders to be reduced.

However, when a plurality of pictures is subjected to down-decoding processing, spatial frequencies and motion vectors are manipulated in a fixed manner according to an input picture format For example, as shown in FIG. 3, when a larger picture 32 and a smaller picture 33 are displayed simultaneously on a display 31, the number of pictures displayed is 2, and therefore ½ of a resource for decoding processing is assigned to each picture in a fixed manner irrespective of the display sizes of the pictures 32 and 33. Then, the spatial frequencies and motion vectors are manipulated with this resource to carry out down-decoding processing. Then, the respective decoded signals are scaled to the display size of the picture 32 and the display size of the picture 33.

In this way, down-decoding processing is carried out by manipulating spatial frequencies and motion vectors in a fixed manner irrespective of the display sizes of the pictures, the pictures 32 and 33 are assigned the same amount of resource, causing the quality of the larger picture 32 to become inferior to the quality of the smaller picture 33.

The present invention has been implemented in view of the above-described problem and it is an object of the present invention to provide a device and a method for decoding and a digital broadcast receiving apparatus capable of displaying a plurality of pictures with proper quality corresponding to a display size simultaneously on a screen.

### SUMMARY OF THE INVENTION

The present inventor has come up with the present invention noticing that conventional down-decoding processing assigns resources in a fixed manner irrespective of the display size and manipulates motion vectors and spatial frequencies, which causes the quality of pictures to deteriorate depending on the expression mode and discovering that it is possible to display pictures with proper quality corresponding to the display size by assigning resources of decoding processing according to the display size and manipulating motion vectors and spatial frequencies.

That is, the subject matter of the present invention is to display pictures with proper quality corresponding to a display size by performing inverse discrete cosine transform and movement compensation/interframe predictive decoding processing with resource assigned on the basis of a display size. When a plurality of pictures in different display sizes is displayed simultaneously on a screen, this prevents differences in the display quality among pictures and prevents, for example, the display quality of large pictures from deteriorating.

The decoding device of the present invention is characterized by comprising resource assigning means for assigning a resource of decoding processing on the basis of display size information of at least two pictures to be displayed on a screen, inverse discrete cosine transforming means for inverse discrete cosine transforming an MPEG coded signal per picture with resource assigned in the resource assigning means, movement compensation/interframe predictive decoding means for movement compensation/interframe predictive decoding the inverse discrete cosine transformed signal per picture with resource assigned in the resource assigning means and scaling means for scaling the movement compensation/interframe predictive decoded signal to display the picture on the screen.

The digital broadcast receiving apparatus is characterized by comprising the above-described decoding device.

According to these configurations, inverse discrete cosine transforms and movement compensation/interframe predictive decoding processing are performed with resources assigned according to the display size, and therefore it is possible to display pictures with proper quality corresponding to the display size. When a plurality of pictures in different display sizes is displayed simultaneously on a screen, this prevents differences in the display quality among pictures and prevents, for example, the display quality of large pictures from deteriorating.

The decoding method of the present invention is characterized by comprising the steps of assigning a resource of decoding processing on the basis of display size information of at least two pictures to be displayed on a screen, inverse discrete cosine transforming an MPEG coded signal per picture with resource assigned in the resource assigning step, movement compensation/interframe predictive decoding the inverse discrete cosine transformed signal per picture with resource assigned in the resource assigning means and scaling the movement compensation/interframe predictive decoded signal to display the picture on the screen.

### BRIEF DESCRIPTION OF THE DRAWINGS

FIG. 1 is a block diagram showing an arrangement of the decoding device according to an embodiment of the present invention;

FIG. 2 is a block diagram showing an arrangement of the digital broadcast receiving apparatus with the decoding device according to an embodiment of the present invention; and

FIG. 3 is a view showing a displayed picture.

### DESCRIPTION OF THE PREFERRED EMBODIMENT(S)

With reference now to the attached drawings, embodiments of the present invention will be explained in detail below. This embodiment will describe a case where two pictures (pictures 32 and 33 in FIG. 3) are displayed on a screen.

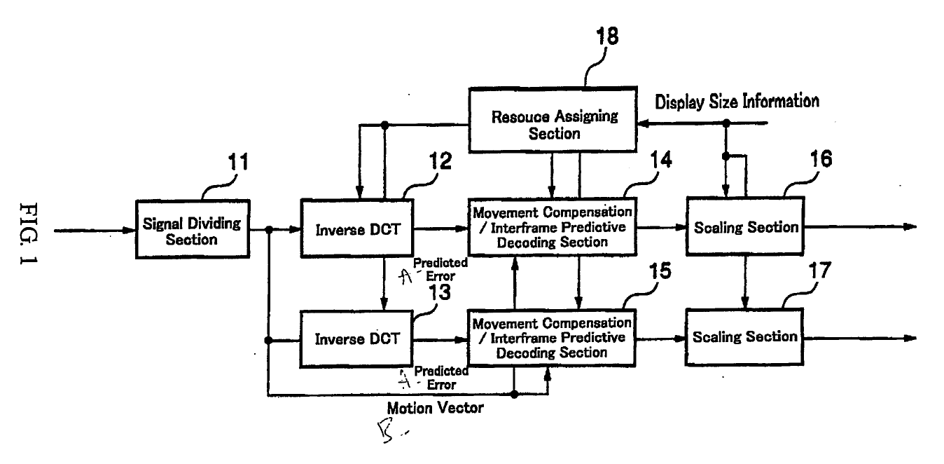

FIG. 1 is a block diagram showing an arrangement of the decoding device according to an embodiment of the present invention. The decoding device shown in FIG. 1 is mainly constructed of a signal dividing section 11 that divides a signal into a DCT coefficient and motion vector information, inverse discrete cosine transforms 12 and 13 that perform inverse discrete cosine transform (inverse DCT transform) on the decoded signal, movement compensation/interframe predictive decoding sections 14 and 15 that perform movement compensation/interframe predictive decoding processing on the inverse DCT transformed signal, scaling sections 16 and 17 that perform scaling on the movement compensation/interframe predictive decoded signal and a resource assigning section 18 that assigns resources on the basis of display size information from the scaling sections 16 and 17.

In the decoding apparatus in the above-described configuration, motion vector information and a DCT coefficient are sent to the signal dividing section 11. The signal dividing section 11 divides the signal into the motion vector information and DCT coefficient, outputs the motion vector to the movement compensation/interframe predictive decoding sections 14 and 15 and outputs the DCT coefficient to the inverse DCT sections 12 and 13. The signal dividing section 11 also separates the DCT coefficients of two pictures 32 and 33 to be displayed on the screen, outputs the DCT coefficient of one picture 32 to the inverse DCT section 12 and outputs the DCT coefficient of the other picture 33 to the inverse DCT section 13.

Information on the display size of a final picture to be displayed on the screen is sent to the resource assigning section 18. On the basis of the information on the display size, the resource assigning section 18 assigns resources among pictures for decoding processing such as inverse DCT processing and movement compensation/interframe predictive decoding. The resource assigning section 18 assigns more resources to a larger picture and assigns fewer resources to a smaller picture. Here, the picture 32 has a larger size, and so it is assigned more resources. The picture 33 has a smaller size, and so it is assigned fewer resources. The, the resource assigning section 18 outputs the resource assignment information determined in this way to the inverse DCT sections 12 and 13 and the movement compensation/interframe predictive decoding sections 14 and 15 as the factors of the respective processing sections.

The inverse DCT sections 12 and 13 perform inverse DCT processing with the resources determined by the resource assigning section 18 using the respective DCT coefficients to obtain estimation errors. The inverse DCT section 12 obtains the estimation error of the picture 32 and the inverse DCT section 13 obtains the estimation error of the picture 33. Then, the inverse DCT sections 12 and 13 output these estimation errors to the movement compensation/interframe predictive decoding sections 14 and 15. That is, the estimation error of the picture 32 obtained from the inverse DCT section 12 is output to the movement compensation/interframe predictive decoding section 14 and the estimation error of the picture 33 obtained from the inverse DCT section 13 is output to the movement compensation/interframe predictive decoding section 15.

The movement compensation/interframe predictive decoding sections 14 and 15 perform movement compensation/interframe predictive decoding processing with the factors determined by the resource assigning section 18 using the motion vectors and estimation errors to obtain a reconstructed picture. That is, the movement compensation/interframe predictive decoding section 14 obtains the reconstructed picture of the picture 32 and the movement compensation/interframe predictive decoding section 15 obtains the reconstructed picture of the picture 33. Then, the movement compensation/interframe predictive decoding sections 14 and 15 output these reconstructed pictures to the scaling sections 16 and 17. That is, the reconstructed picture of the picture 32 obtained from the movement compensation/interframe predictive decoding section 14 is output to the scaling section 16 and the reconstructed picture of the picture 33 obtained from the movement compensation/interframe predictive decoding section 15 is output to the scaling section 17.

The scaling sections 16 and 17 convert formats according to a final picture image and perform scaling on the reconstructed pictures on the basis of the display size information. That is, the scaling section 16 performs scaling on the reconstructed picture of the picture 32 and the scaling section 17 performs scaling on the reconstructed picture of the picture 33. At this time, as shown in FIG. 3, the picture 32 is scaled to a relatively large size and the picture 33 is scaled to a relatively small size. The pictures 32 and 33 scaled in this way are displayed on the screen 31 as shown in FIG. 3.

Thus, resources are assigned for decoding processing according to the display size of the final picture output, that is, processing for filtering factors and motion vectors with spatial frequencies in the decoding processing is changed according to the display size, and therefore it is possible to display proper quality corresponding to the display size. As a result pictures can be displayed with optimum display quality irrespective of the display size compared to the conventional method that displays a plurality of pictures on the screen. Especially, this method can prevent deterioration of display quality of relatively large pictures.

Here, a specific example will be explained. A case where two 1080i MPEG pictures are displayed on the screen will be explained. In this case, the display size of one picture is reduced to ½ of the screen and the display size of the other picture is reduced to ⅛ of the screen.

In this case, the picture whose display size is reduced to ½ of the screen (abbreviated as a “½ picture”) is relatively large, and therefore it is required to have higher quality than that of the picture whose display size is reduced to ⅛ of the screen (abbreviated as a “⅛ picture”). For this reason, more resources are assigned to the ½ picture than the ⅛ picture. More specifically, the ½ picture is assigned resources 4 times as many as those assigned to the ⅛ picture.

First, with respect to the filtering factor about spatial frequencies in block units, the filtering factor of the ½ picture is set to be four times that of the ⅛ picture. That is, the filtering factor about spatial frequencies for the ½ picture is set to ½ of the original factor and the filtering factor about spatial frequencies for the ⅛ picture is set to ⅛ of the original factor. Furthermore, with respect to the motion vector, the motion vector of the ½ picture is set to be four times that of the ⅛ picture. That is, the motion vector for the ½ picture is set to ½ of the original motion vector and the motion vector for the ⅛ picture is set to ⅛ of the original motion vector.

This makes it possible to display pictures with proper quality corresponding to the display size and even when the ½ picture and ⅛ picture are displayed simultaneously on the screen, there will be no difference in quality between both pictures and the display quality of the ½ picture will not deteriorate.

Then, the digital broadcast receiving apparatus according to this embodiment will be explained.

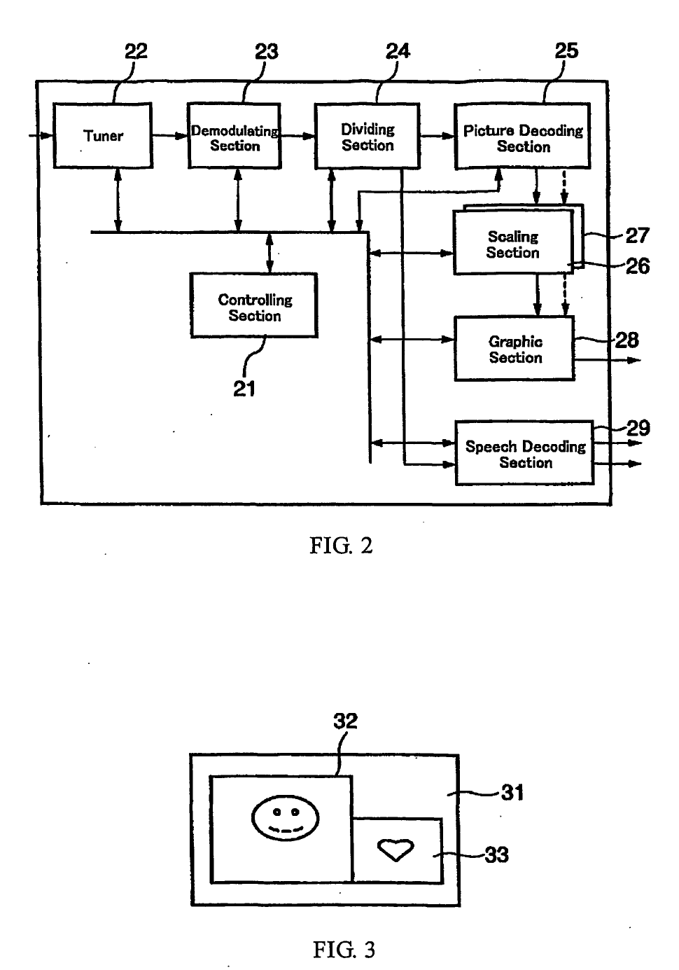

FIG. 2 is a block diagram showing an arrangement of the digital broadcast receiving apparatus with the decoding device according to the embodiment of the present invention shown in FIG. 1.

The digital broadcast receiving apparatus shown in FIG. 2 is mainly constructed of a controlling section 21 that controls the entire apparatus, a tuner 22 that extracts/detects a desired signal, a demodulating section 23 that demodulates the detected signal, a dividing section 24 that divides the demodulated signal into a picture signal and a speech signal, a picture decoding section 25 that carries out picture decoding processing on the picture signal, scaling sections 26 and 27 that perform scaling on the reconstructed pictures, a graphic section 28 that combines the scaled picture with other information and a speech decoding processing section 29 that performs speech decoding processing on the speech signal.

In the digital broadcast receiving apparatus in the above-described configuration, a satellite digital broadcast BS-IF signal received through a parabolic antenna is input from an input terminal and sent to the tuner 22. The tuner 22 extracts a desired signal on the basis of tuning data from the controlling section 21, detects it and outputs the baseband modulated signal obtained to the demodulating section 23.

The demodulating section 23 carries out demodulation processing on the baseband modulated signal, then carries out error correction processing, generates a transport stream (TS) and outputs this TS to the dividing section 24. The dividing section 24 divides the TS into a multiplexed MPEG picture signal and MPEG speech signal, outputs the MPEG picture signal to the picture decoding section 25 and outputs the LEG speech signal to the speech decoding section 29.

The speech decoding section 29 carries out speech decoding processing on the MPEG speech signal, converts it to an analog speech signal ultimately and outputs it from the speech output terminal.

On the other hand, the picture decoding section 25 carries out picture decoding processing on the MPEG picture signal from the dividing section 24. At this time, when a plurality of pictures is displayed on the screen simultaneously, inverse discrete cosine transform and movement compensation/interframe predictive decoding processing are performed with the resources assigned according to the display size during decoding processing as described above. At this time, the display size information is given from the controlling section 21.

The reconstructed pictures obtained (pictures to be displayed simultaneously) are sent to the scaling sections 26 and 27. The scaling sections 26 and 27 convert formats according to the ultimate output images specified by the controlling section 21 and then scale the pictures to sizes according to the ultimate picture images.

The scaled digital picture signals are sent to the graphic section 28. The graphic section 28 combines them with on-screen information such as program information and interface, etc., specified by the controlling section 21 and converts the digital picture signals to analog picture signals ultimately and outputs these analog picture signals from the picture output terminal.

Thus, when the digital broadcast receiving apparatus displays a plurality of pictures on the screen simultaneously, it can display pictures with optimum display quality irrespective of the display size compared to the conventional method. Especially, this apparatus can prevent deterioration of display quality of relatively large pictures.

The present invention is not limited to the above-described embodiments, but can be implemented modified in various ways. For example, the above-described embodiments have described the case where two pictures are displayed on the screen, but the present invention can also be implemented for a case where three or more pictures are displayed on the screen by assigning resources appropriately. Furthermore, numerical values and magnitudes in the above-described embodiments are not limited to particular values, but can be modified in various ways.

As described above, the present invention performs inverse discrete cosine transform and movement compensation/interframe predictive decoding processing with resources assigned according to the display size, and can thereby display pictures with proper quality corresponding to the display size. In this way, even if a plurality of pictures of different display sizes is displayed simultaneously on the screen, no difference in the display quality is produced among pictures, thus preventing, for example, the display quality of large pictures from deteriorating.

This application is based on the Japanese Patent Application No. 2002-224653 filed on Aug. 1, 2002, entire content of which is expressly incorporated by reference herein.

1. A decoding device comprising:
resource assigning means for assigning a resource of decoding processing on the basis of display size information of at least two pictures to be displayed on a screen;
inverse discrete cosine transforming means for inverse discrete cosine transforming an MPEG coded signal per said picture with resource assigned in said resource assigning means;
movement compensation/interframe predictive decoding means for movement compensation/interframe predictive decoding said inverse discrete cosine transformed signal per said picture with resource assigned in said resource assigning means; and scaling means for scaling said movement compensation/interframe predictive decoded signal to display said picture on the screen.

2. A digital broadcast receiving apparatus having a decoding device according to claim 1.

3. A decoding method comprising the steps of:
assigning a resource of decoding processing on the basis of display size information of at least two pictures to be displayed on a screen;
inverse discrete cosine transforming an MPEG coded signal per said picture with resource assigned in said resource assigning step;
movement compensation/interframe predictive decoding said inverse discrete cosine transformed signal per said picture with resource assigned in said resource assigning means; and
scaling said movement compensation/interframe predictive decoded signal to display said picture on the screen.
